(19) United States
(12) Patent Application Publication
(10) Pub. No.: US 2003/0050965 A1
(43) Pub. Date: Mar. 13, 2003

(54) Browser-controlled copying system and method

(76) Inventor: Brett Green, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/950,253

(22) Filed: Sep. 10, 2001

(51) Int. Cl. G06F 15/16

(52) U.S. Cl. 709/203

(57) ABSTRACT

The present disclosure relates to a browser-controlled copying system and method. In one arrangement, the system is configured for and the method comprises receiving a copy request from a user browser, uploading content to the user browser, receiving selections made with the user browser, and generating at least one hardcopy of the document in accordance with the user selections. The present disclosure further relates to a copying device. In one arrangement, the copying device comprises a processing device, copying hardware, and memory comprising a copy control module and an embedded server, the copy control module logic for generating at least one control screen that can be uploaded to a user browser so that operation of the copying device can be controlled with the control screen.

### FIELD OF THE INVENTION

The present disclosure relates to a browser-controlled copying system and method. More particularly, the disclosure relates to a system and method in which the operation of a copying device is controlled such that documents can be copied under the control of a user browser.

### BACKGROUND OF THE INVENTION

Peripheral devices are adapted to be accessed and used by computing devices such as a personal computer (PC). Traditionally, printers were accessible in this manner while other “office” devices were only configured for “walk-up” use. With the recent focus on networking technology, however, many other devices can be accessed and used with a host computing device. For example, photocopiers, facsimile machines, copiers, multifunction peripherals (MFPs) capable of several different functionalities traditionally conducted by separate devices, network appliances, etc. are currently available that are configured for this type of use.

To enable such access and control, one or more software applications normally must be stored on the user's computing device. Such applications typically comprise a user interface and one or more device drivers. The user interface is provided as a means for receiving user commands and selections regarding the tasks the user wishes to be completed by the end device and the device drivers are configured to send jobs from the computing device to the end device to fulfill the requested tasks.

Typically, each end device to be accessed by the computing device has its own separate software application. Moreover, separate software applications are typically needed for each different functionality the end device performs where it performs more than one functionality (e.g., copying, faxing, copying, and printing). Normally, these software applications are not standardized. Therefore, the layout of the user interface and the manner in which the end device is controlled may be different for each application; even for different devices made by the same manufacturer and for single devices that provide multiple functionalities.

The arrangement described above presents several disadvantages to the user as well as the device manufacturer. With regard to the user, the user must install separate software for each different device and/or functionality the user plans to use. In addition, the user may need to update this software when new software becomes available from the device manufacturer (e.g., updated driver software). This is very time-consuming for the user and places a burden upon the user to keep apprised of any software improvements that have been made by the device manufacturer. Once the software has been installed by the user, the user must become familiar with each different software application, both in terms of the user interface and the manner in which the software is used to control the device and/or functionality. This can be frustrating for the user, particularly where the user must access many different devices and/or functionalities.

In terms of the device manufacturer, disadvantages include having to reconfigure the software as the underlying operating environment (e.g., Windows™, Unix™) is changed by third parties as well as having to provide new software (for any purpose) to the various purchasers of a given device as the new software is developed. Furthermore, device manufacturers normally must provide customer support for all versions of software that have been produced in that some users may still have old versions of the software. In some situations, valuable time may be lost in just determining what software the user possesses.

From the foregoing, it can be appreciated that it would be desirable to have a system and method for accessing and using a device that avoids one or more of the difficulties identified above.

### SUMMARY OF THE INVENTION

The present disclosure relates to a browser-controlled copying system and method. In one arrangement, the system is configured to and the method comprises receiving a copy request from a user browser, uploading content to the user browser, receiving selections made with the user browser, and generating at least one hardcopy of the document in accordance with the user selections.

The present disclosure further relates to a copying device. In one arrangement, the copying device comprises a processing device, copying hardware, and memory comprising a copy control module and an embedded server, the copy control module logic for generating at least one control screen that can be uploaded to a user browser so that operation of the copying device can be controlled with the control screen.

Other systems, methods, features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example browser-controlled copying system.

FIG. 2 is a schematic view of a computing device shown in FIG. 2.

FIG. 3 is a schematic view of a copying device shown in FIG. 2.

FIG. 4 is a flow diagram that illustrates use of the browser of the computing device shown in FIG. 3 in controlling the copying device.

FIG. 5 is a schematic representation of content that is uploaded into the browser shown in FIG. 2.

FIG. 6 is an example control screen that can be presented to the user with the browser shown in FIG. 2.

FIG. 7 is a flow diagram that illustrates operation of a copy control module of the copying device shown in FIG. 3.

### DETAILED DESCRIPTION

Disclosed herein is a copying system and method that is controlled with the user's browser. With this system and method, a browser is used to receive content that, as is described in greater detail below, can comprise one or more pages or screens that can be used to control a copying device. In addition, this content may further comprise small applications (e.g., Java applets) that are embedded in the hypertext markup language (HTML) code of the page displayed by the browser that are configured to perform various designated tasks for the copying device.

The browser can be used to initiate copying and, where desired, adjust various settings of the copying device. Operating in this manner, the user can control all copying with the user's browser. Accordingly, use of the inventive system and method does not require installation of a separate application and permits the user to utilize an interface with which the user is already familiar. As is discussed below, this arrangement is well-suited for accessing and controlling local “convenience copiers.”

To facilitate description of the invention, an example browser-controlled copying system will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which copying control can be achieved.

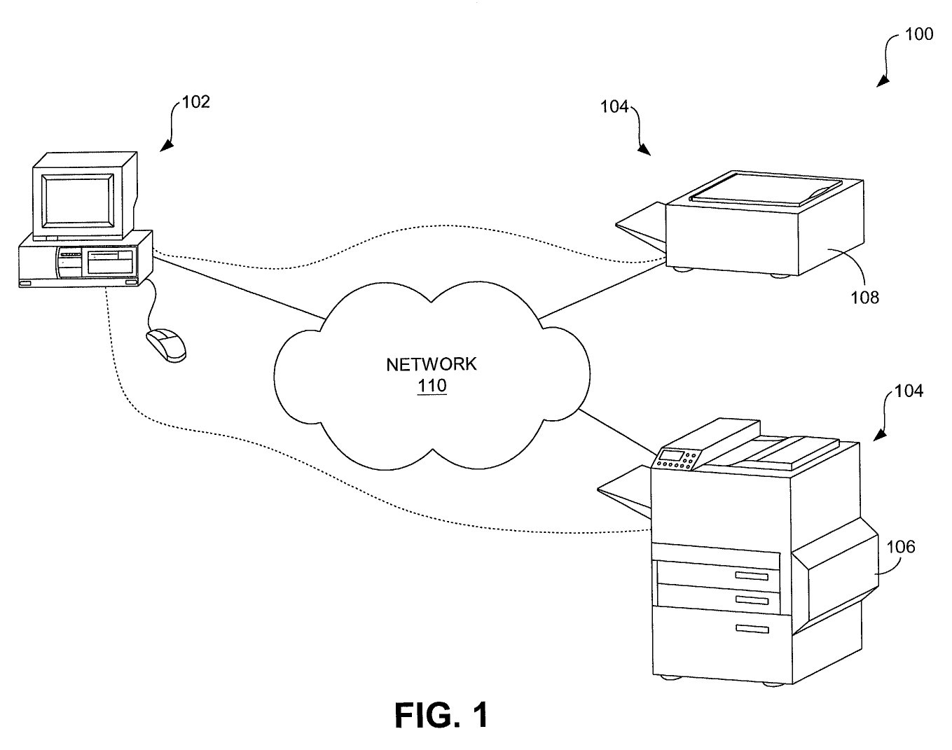

Referring now in more detail to FIG. 1, illustrated is an example browser-controlled copying system 100. As indicated in this figure, the system 100 generally comprises a computing device 102 and one or more copying devices 104. As shown in FIG. 1, the computing device 102 can comprise a personal computer (PC). However, it is to be understood that the computing device 102 can comprise substantially any device that can be used to access and use a copying device. Therefore, the computing device could, alternatively, comprise a laptop computer, personal digital assistant (PDA), mobile telephone, etc. For the purposes of this disclosure, the term “copying device” is used to denote any device that is capable of electronically copying data. Therefore, the copying device 104 can, for instance, comprise an independent photo copier 106 or a multifunction peripheral (MFP) 108, sometimes referred to as an “all-in-one,” that is capable of copying as well as other different functionalities.

As is further identified in FIG. 1, the computing device 102 and the copying devices 104 can be connected to a network 110. The network 110 typically comprises one or more sub-networks that are communicatively coupled to each other. By way of example, these networks can include one or more local area networks (LANs) and/or wide area networks (WANs). Indeed, in some embodiments, the network 110 may comprise a set of networks that forms part of the Internet. As is also depicted in FIG. 1, the computing device 102 can, optionally, be directly connected to one or both of the copying devices 104. Such an arrangement is likely in a home or small office environment in which the user does not have access to a network and instead directly communicates to a copying device 104. In such a scenario, communication can be facilitated with a direct electrical and/or optical connection or through wireless communication.

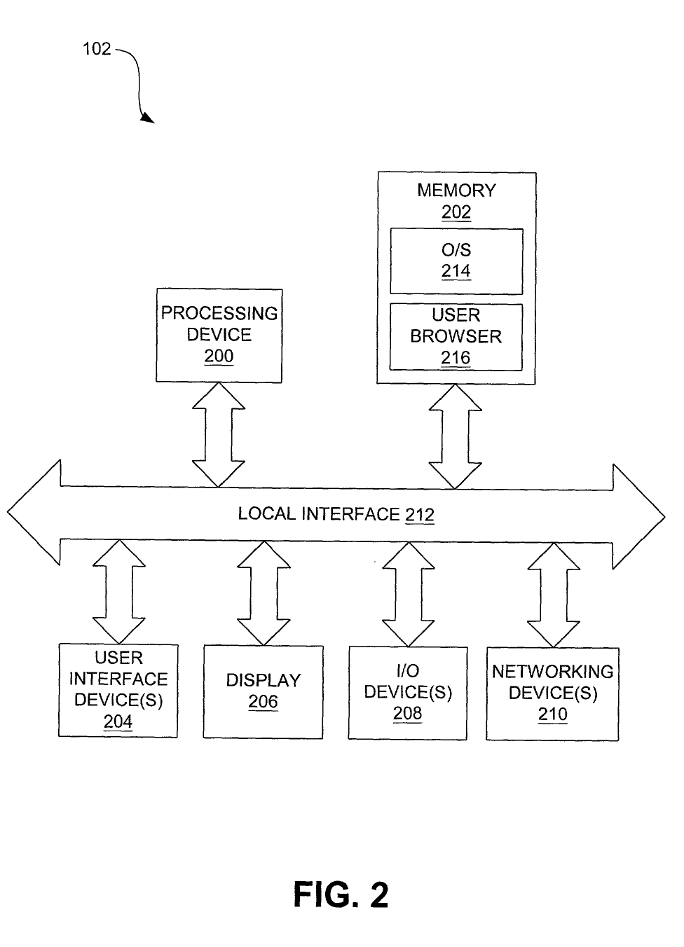

FIG. 2 is a schematic view illustrating an example architecture for the computing device 102 shown in FIG. 1. As indicated in FIG. 2, the computing device 102 can comprise a processing device 200, memory 202, one or more user interface devices 204, a display 206, one or more I/O devices 208, and one or more networking devices 210, each of which are connected to a local interface 212. The processing device 200 can include any custom made or commercially available processor, a central processing unit (CPU) or an auxiliary processor among several processors associated with the computing device 102, a semiconductor based microprocessor (in the form of a microchip), or a macroprocessor. The memory 202 can include any one of a combination of volatile memory elements (e.g., random access memory (RAM, such as DRAM, SRAM, etc.)) and nonvolatile memory elements (e.g., ROM, hard drive, tape, CDROM, etc.).

The one or more user interface devices 204 comprise those components with which the user can interact with the computing device 102. Where the computing device 102 comprises a PC or similar device, these components can comprise those typically used in conjunction with a PC such as a keyboard and mouse. Where the computing device 102 comprises a handheld device such as a PDA or mobile telephone, the user interface devices 204 can comprise one or more function buttons or keys. The display 206 can comprise a display typically used in conjunction with a PC such as a computer monitor or plasma screen. Where the computing device 102 comprises a handheld device, the display 206 can comprise a liquid crystal display (LCD) that may or may not be touch-sensitive.

The one or more I/O devices 208 comprise components used to facilitate connection of the computing device 102 to other devices directly, such as the copying devices 104. Therefore, these devices can, for instance, comprise one or more serial, parallel, small system interface (SCSI), universal serial bus (USB), IEEE 1394 (e.g., Firewire™), or personal area network (PAN) connection devices. The networking devices 210 comprise the various components used to transmit and/or receive data over the network 110. By way of example, the networking devices 210 include a device that can communicate both inputs and outputs, for instance, a modulator/demodulator (e.g., modem), a radio frequency (RF) or other transceiver, a telephonic interface, a bridge, a router, as well as a network card, etc.

The memory 202 normally comprises various software programs including an operating system 214 and a user browser 216. Although various other software programs may be stored in memory 202, they are typically not required to obtain the copying control that is the subject of the present disclosure and therefore have not been identified. The operating system 214 controls the execution of other software, such as the browser 216, and provides scheduling, input-output control, file and data management, memory management, and communication control and related services. The browser 216 comprises the software that is used to browse data over the network 110 and, as described in greater detail below, thereby access and use the copying devices 104. The browser 216 typically comprises various different components such as a user application that the user can run on the computing device 102 to interface with the browser software. The browser can, for example, comprise a currently available Internet browser such as Microsoft Internet Explorer™ or Netscape Navigator™.

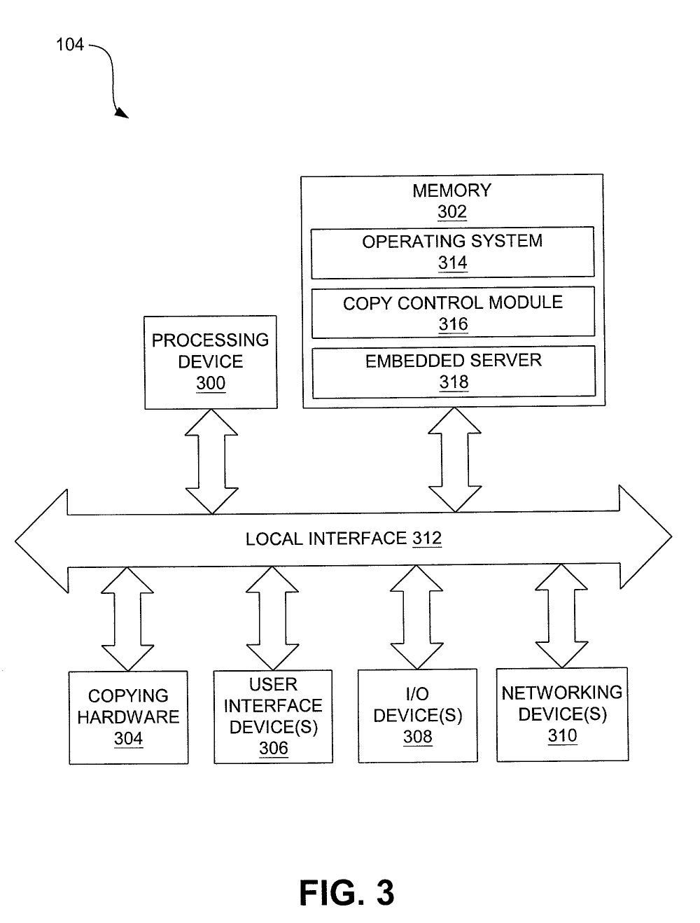

FIG. 3 is a schematic view illustrating an example architecture for the copying devices 104 shown in FIG. 1. As indicated in FIG. 3, each copying device 104 can comprise a processing device 300, memory 302, copying hardware 304, one or more user interface devices 306, one or more I/O devices 308, and one or more networking devices 310. Each of these components is connected to a local interface 312 that, by way of example, comprises one or more internal buses. The processing device 300 is adapted to execute commands stored in memory 302 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the copying device 104.

The copying hardware 304 comprises the components with which the copying device 104 can create an electronic copy of a hardcopy document. Accordingly, the copying hardware 304 can comprise, for instance, a paper drive mechanism, light source (e.g., fluorescent light), light-sensing devices (e.g., charge-coupled devices (CCDs)), and various optics (e.g., lenses, mirrors). The one or more user interface devices 306 typically comprise interface tools with which the device settings can be changed and through which the user can communicate commands directly to the copying device 104. By way of example, the user interface devices 306 comprise one or more function keys and/or buttons with which the operation of the copying device 104 can be controlled, and a display, such as a liquid crystal display (LCD), with which information can be visually communicated to the user. Notably, in some embodiments the copying device 104 may not have such user interface devices. For example, a low-cost version of the copying device 104 could come without the interface devices and control could be provided by the browser 216 alone. Finally, the I/O devices 308 and networking devices 310 can have configurations similar to like-named components identified above with reference to FIG. 2.

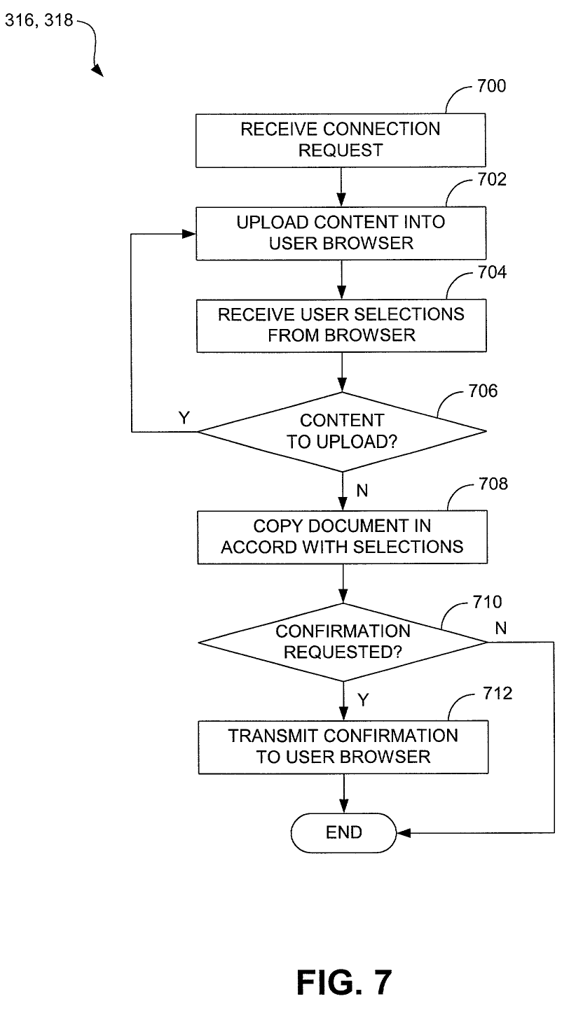

The memory 302 includes various software (e.g., firmware) programs including an operating system 314, copy control module 316, and an embedded server 318. The operating system 314 contains the various commands used to control the general operation of the copying device 104. The copy control module 316 comprises the various code used to control the operation of the copying hardware 304 in response to commands received from the user. The operation of the copy control module 316 is described in detail with respect to FIG. 7 below. The server 318 comprises the software (e.g., firmware) that is used to serve-up data to browsers that request the data. By way of example, the data can comprise one or more pages or control screens and one or more small programs that are configured to perform designated tasks.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical copying of the paper or other medium, then compiled, interpreted or otherwise processed in a suitable manner if necessary, and then stored in a computer memory.

An example system 100 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

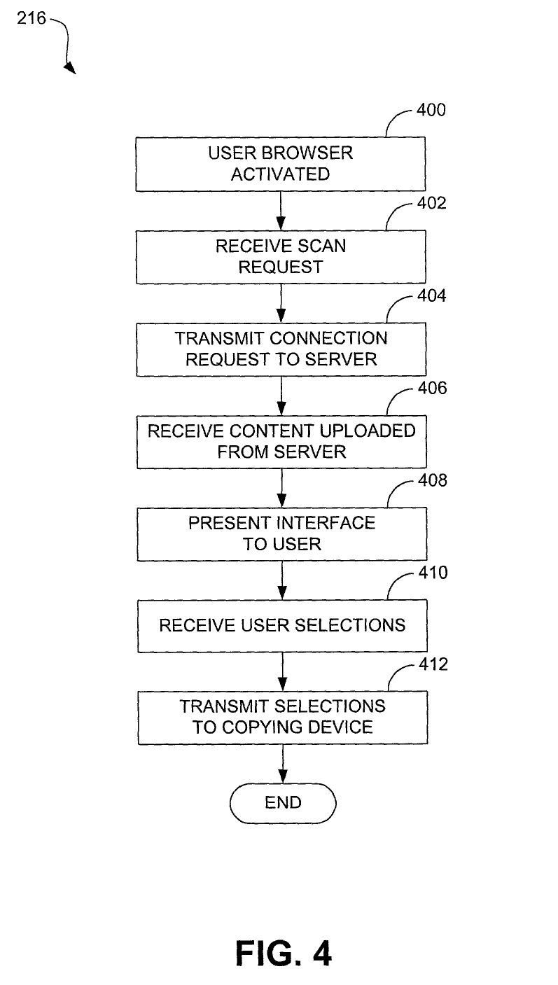

As noted above, the system 100 generally operates so as to facilitate control of a copying device with the user's browser, for example, browser 216. An example of the operation of the browser 216 as used to control a copying device 104 is provided in FIG. 4. Beginning with block 400 of this figure, the browser 216 is first activated. This activation can occur in a variety of different ways. Typically, however, activation occurs in response to the user opening the browser 216 from the system desktop. In any case, once activated, a copy request can be received from the user, as indicated in block 402. This request can be transmitted via the network 110 or through a direct connection. In that copying will ultimately be conducted by the copying device 104, the copy request is also a request to access the copying device. The copy request can be entered in a variety of ways. In a simplified case, the user can have entered the network address of the server 318 of the copying device 104. By way of example, this address can comprise a universal resource locator (URL) that the browser 216 can use to make calls to the copying device server 318.

In another case, the user can have selected a “copying device” link stored within a “favorites” listing that forms part of the browser 216. By way of example, this link could have been created manually by the user, automatically added to the favorites list by content uploaded to the browser 216 when the server 318 is first accessed with the browser, etc. In a further case, the user can have selected a “copy” button provided on the tool bar of the browser 216 which again was either manually added by the user or automatically added by content uploaded to the browser.

Once the copy request has been received, and the address of the copying device 104 therefore has been provided, the browser 216 transmits a connection request to the server 318 of the copying device 104, as indicated in block 504. This request is then received by the server 318 and the server maps the address of the browser 216 to one or more pages. Through this action, various content is uploaded to the browser 216 and is therefore “received” by the browser, as indicated in block 406. As will be appreciated by persons having ordinary skill in the art, the nature of this content depends upon the operations desired.

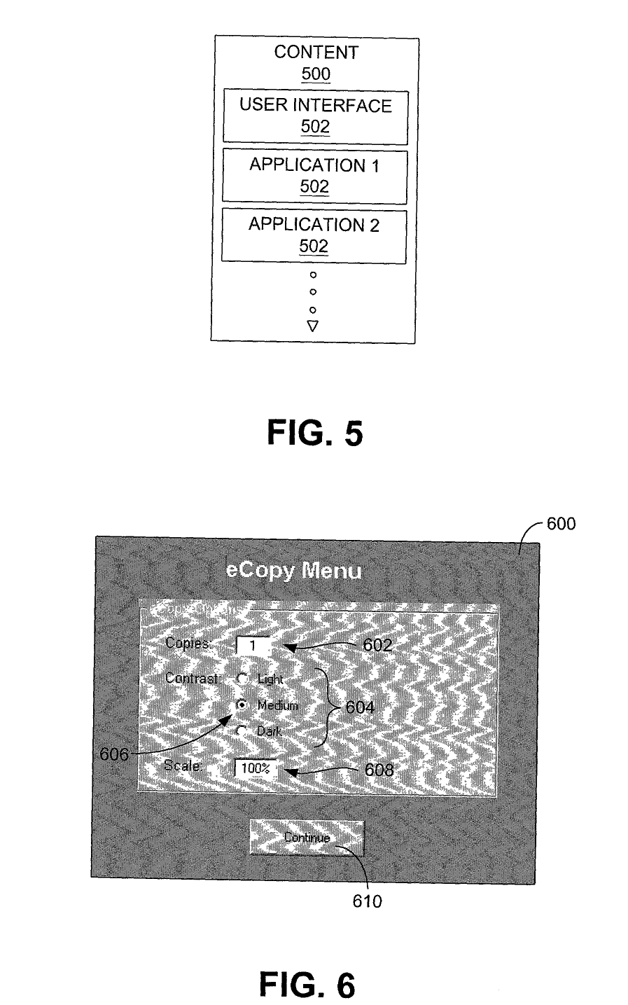

A schematic representation of the uploaded content is provided in FIG. 5. As indicated in this figure, the content 500 can comprise a user interface 502, such as a graphical user interface (GUI), with which the user can make selections to communicate commands to the copying device 104. This user interface 502 is configured to present to a series of pages or control screens to the user that are viewable in a viewing window of the browser 216. In addition to the interface 502, the content 500 can comprise a plurality of small applications 504, generally referred to as applets (e.g., Java applets), that are configured to perform various tasks. For example, as discussed below, one application 504 can be configured to transmit user selections to the copying device that have been selected by the user.

Once the content 500 has been received, the user interface is presented to the user, as indicated in block 408. Where the interface comprises a GUI, one or a series of pages or control screens can be displayed to the user in the viewing window of the browser 216. FIG. 6 provides an example control screen that can be displayed to the user. In particular, FIG. 6 illustrates a copy menu screen 600 that can be displayed to the user. By way of example, this menu screen 600 can be the first screen that is presented to the user. However, it is to be understood that this menu screen 600 need not necessarily be the first. For instance, where the copying device 104 is capable of performing other functions (e.g., scanning or printing), the first screen presented to the user may request the user to designate which of the particular available device functionalities is to be accessed.

As is apparent from FIG. 6, the copy menu screen 600 can present the user with option of entering various information. For example, the user can select the number of copies that are to be made by entering a number in a field 602 provided in the screen 600. In addition, the user can, for instance, select the contrast with which hardcopies are to be generated by choosing one of several different contrast options 604 (e.g., light, medium, and dark). This choice can be registered by the user by marking one of several check “boxes” 606 provided on the screen 600. Furthermore, the user can select the scale at which the hardcopy is to be generated. Again, this information can be entered with a field 608 provided on the screen 600. Once the user is satisfied with his or her various sections, the user can select a “Continue” button 610 that is provided at the bottom of the copy menu screen 600.

Returning now to FIG. 4, the browser 216 can receive the user's selections, as indicated in block 410, and transmit the selections to the copying device 104, as indicated in block 412. Although not shown in the figures, it will be appreciated that other pages or control screens could first be presented to the user, if desired. For example, after completing the copy menu screen 600, the user can be provided with more detailed options screens with which the user can specify various other copying related information (e.g., copy resolution, down sampling, etc.).

At this point, the copying selections can be received by the copying device 104 and the requested copying can be performed. Referring now to FIG. 7, illustrated is an example of operation of the copying device 104 in this capacity. More particularly, FIG. 7 illustrates an example of the operation of the copy control module 316 and the server 318 of the copying device 104, which work in concert to perform the desired functionalities. The server 318, and therefore copy control module 316, first receives the connection request from the browser 216 in the manner described above, as indicated in block 700. At this point, the copy control module 316 identifies the content that is to be provided to the browser 216 so that, as indicated in block 702, the content can be uploaded into the browser. Again, this content can comprise user interfaces and, optionally, various applications (e.g., Java applets) that are configured to perform various designated tasks. Next, the user selections (e.g., user selections as the number of copies, contrast, etc.) can be received from the browser 216, as indicated in block 704.

As the selections are received, it is determined whether more content is to be uploaded, as indicated in decision element 706. For example, if the user completes and transmits the copy menu screen 600, such additional content can include the next sequential screen to be displayed to the user. If further content is to be uploaded, flow returns to block 702 at which the content is uploaded to the browser 216. If, on the other hand, no additional content is to be provided to the browser, i.e., all information necessary for conducting a copy has been provided by the user, flow continues to block 708 at which the document is copied in accordance with the user selections and one or more hardcopies are generated. As mentioned above, this copying is performed by the copying module 320 in conjunction with the copying hardware 304.

Referring to decision element 710, it can then be determined whether the user has requested confirmation that the copying device 104 has generated the one or more hardcopies. By way of example, this selection can have been made by marking an appropriate selection on one of the control screens presented to the user with in the browser 216. If such confirmation had not been requested, flow is terminated. If, however, the user did request confirmation, flow continues to block 712 at which a confirmation notice is transmitted to the browser 216.

As will be appreciated from the above discussion, several advantages are provided with the disclosed system and method. First, in that all the software necessary for providing copy control is stored on the copying device 104 and uploaded from that device to the user's browser 216, there are no software applications for the user to download. In that the user's browser 216 is used as the user interface, the user further does not have to become accustomed to disparate user interfaces of many different applications, thereby providing interface standardization. Furthermore, due to the centralization of the software, any software updates can be implemented on the copying device 104 alone but will be available to all users immediately. Moreover, in that the user's browser is used independently of the user's operating environment, the copying device manufacturer need not rewrite the software every time a third party software manufacturer updates its operating system. Although these advantages have been identified, persons having ordinary skill in the art will appreciate that other advantages exist. Furthermore, such persons will appreciate that, depending upon the particular embodiment that is implemented, one or more of these advantages may not necessarily apply.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for copying a document, comprising the steps of:
receiving a copy request from a user browser;
uploading content to the user browser;
receiving selections made with the user browser; and
generating at least one hardcopy of the document in accordance with the user selections.

2. The method of claim 1, wherein the step of uploading content to the user browser comprises uploading logic configured to generate at least one control screen for display within the browser.

3. The method of claim 1, wherein the step of uploading content to the user browser comprises uploading at least one application that is configured to perform a designated task on a computing device on which the browser runs.

4. The method of claim 3, wherein the at least one application is configured to deliver user selections entered with the browser to a copying device.

5. The method of claim 1, further comprising transmitting a confirmation notice to the browser once the at least one hardcopy has been generated.

6. A system for copying a document, comprising:
means for receiving a copy request from a user browser;
means for uploading content to the user browser;
means for receiving selections made with the user browser; and
means for generating at least one hardcopy of the document in accordance with the user selections.

7. The system of claim 6, wherein the means for uploading content to the user browser comprises an embedded server.

8. The system of claim 6, wherein the means for uploading content to the user browser comprise means for uploading at least one application that is configured to perform a designated task on a computing device on which the browser runs.

9. A system for copying a document, comprising:
logic configured to receive a copy request from a user browser;
logic configured to upload content to the user browser;
logic configured to receive selections made with the user browser; and
copying hardware configured to generate at least one hardcopy of the document in accordance with the user selections.

10. The system of claim 9, wherein the logic configured to upload content to the user browser comprises an embedded server.

11. The system of claim 9, wherein the logic configured to upload content to the user browser comprises logic configured to upload at least one application that is configured to perform a designated task on a computing device on which the browser runs.

12. A copying device, comprising:
a processing device;
copying hardware; and
memory comprising a copy control module and an embedded server, the copy control module logic for generating at least one control screen that can be uploaded to a user browser so that operation of the copying device can be controlled with the control screen.

13. The device of claim 12, wherein the memory further comprises at least one application that can be uploaded to the user browser.

14. The device of claim 12, wherein the memory further comprises logic configured to transmit a confirmation notice to the browser once a hardcopy has been generated by the copying device.

15. The device of claim 12, wherein the copying device comprises a multifunction peripheral.
